(19) United States
(12) Patent Application Publication
(10) Pub. No.: US 2014/0210728 A1
(43) Pub. Date: Jul. 31, 2014

(54) FINGERPRINT DRIVEN PROFILING

(71) Applicant: VERIZON PATENT AND LICENSING INC., Basking Ridge, NJ (US)

(72) Inventors: Martin A. Busse, Woburn, MA (US); Jimena Velarde Chocano, Arlington, MA (US); Gaurav Mehta, Brookline, MA (US)

(73) Assignee: VERIZON PATENT AND LICENSING INC., Basking Ridge, NJ (US)

(21) Appl. No.: 13/750,298

(22) Filed: Jan. 25, 2013

(51) Int. Cl. G06F 3/041

(52) U.S. Cl. CPC G06F 3/0412
USPC 345/173

(57) ABSTRACT

A method, performed by a computer device, may include detecting a finger on a touchscreen and determining a finger pattern based on a contact area of the finger with the touchscreen. The method may further include selecting content based on the determined finger pattern and presenting the selected content on the touchscreen.

### BACKGROUND INFORMATION

Computer devices may include an input device for receiving input from a user and may include an output device for providing information to the user. A touchscreen may combine the functionality of an input device and an output device. A touchscreen may include a display device, such as a liquid crystal display (LCD), integrated with an array of input sensors to sense when a user's finger touches the touchscreen. The input sensors may include resistive sensors, capacitive sensors, optical imaging sensors, and/or other types of sensors. A user may interact with an object displayed on the touchscreen by touching the displayed object, thereby activating one or more of the input sensors associated with the touched area.

### BRIEF DESCRIPTION OF THE DRAWINGS

FIG. 1 is a diagram illustrating an exemplary computer device according to an implementation described herein;

FIG. 2 is a diagram illustrating an exemplary components of the computer device of FIG. 1 according to an implementation described herein;

FIG. 3A is a diagram illustrating exemplary functional components of the computer device of FIG. 1 according to a first implementation described herein;

FIG. 3B is a diagram illustrating exemplary functional components of the computer device of FIG. 1 according to a second implementation described herein;

FIG. 4A is a graph of fingerprint area distributions according to an implementation described herein;

FIG. 4B is a graph of a relationship between age and finger size according to an implementation described herein;

FIG. 5A is a diagram of exemplary components of the content selection database of FIG. 3A according to an implementation described herein;

FIG. 5B is a diagram of exemplary components of the user profile database of FIG. 3B according to an implementation described herein;

FIG. 6 is a flowchart of an exemplary process of selecting content based on a finger size according to an implementation described herein;

FIG. 7 is a flowchart of an exemplary process of selecting content based on a finger pattern according to an implementation described herein;

FIGS. 8A and 8B are first exemplary user interfaces according to an implementation described herein;

FIGS. 9A and 9B are second exemplary user interfaces according to an implementation described herein; and

FIG. 10 is a diagram of an exemplary table of user profiles according to an implementation described herein.

### DETAILED DESCRIPTION OF PREFERRED EMBODIMENTS

The following detailed description refers to the accompanying drawings. The same reference numbers in different drawings identify the same or similar elements.

Implementations described herein relate to fingerprint driven profiling by a computer device. The computer device, such as a smartphone, a tablet computer, a laptop computer, a desktop computer, or a phablet computer, may include a touchscreen. The computer device may be configured to detect a finger on the touchscreen and to determine a finger pattern based on a contact area of the finger with the touchscreen. The determined finger pattern may be used to select content and the selected content may be presented on the touchscreen.

In some implementations, determining the finger pattern may include determining a size of the finger. The size of the finger may be used to determine an age group of the user. For example, children in a first age group may have a finger size within a first size range, children in a second age group may have a finger size within a second size range, and adults in a third age group may have a finger size in a third size range. The determined age group of the user may be used to select the content that is to be presented on the touchscreen. As an example, if the user unlocks the computer device by touching the touchscreen, the application icons that are displayed may be based on the age group of the user, determined based on the size of the user's finger. As another example, if a user activates an application by touching an application icon, content associated with the application that is presented to the user may be based on the age group of the user, determined based on the size of the user's finger.

In other implementations, determining the finger pattern may include determining a size and a shape of the contact area of the finger. The size and shape of the contact area of the finger may be used to select a user profile from a set of user profiles associated with the computer device. The selected user profile may be used to select the content that is to be presented on the touchscreen. As an example, if a user unlocks the computer device by touching the touchscreen, application icons associated with the selected user profile may be presented on the touchscreen. As another example, if a user activates an application by touching an application icon, application content associated with the selected user profile may be presented on the touchscreen.

In some implementations, determining a finger pattern may include determining a particular pattern associated with a particular type of touchscreen glove. For example, different categories of users working for a company may be provided with different types of touchscreen gloves, with each type of touchscreen glove being associated with a different contact area pattern. The computer device may identify a particular touchscreen glove type based on the size and shape of the contact area and may provide a sequence of user interfaces based on the identified touchscreen glove type.

Furthermore, in some implementations, additional information may be obtained to select a user profile. As an example, a tilt pattern of the computer device may be determined in connection with detecting the finger on the touchscreen and the determined tilt pattern may be used in selecting the user profile. As another example, an audio pattern may be determined in connection with detecting the finger on the touchscreen and the determined audio signal may be used in selecting the user profile.

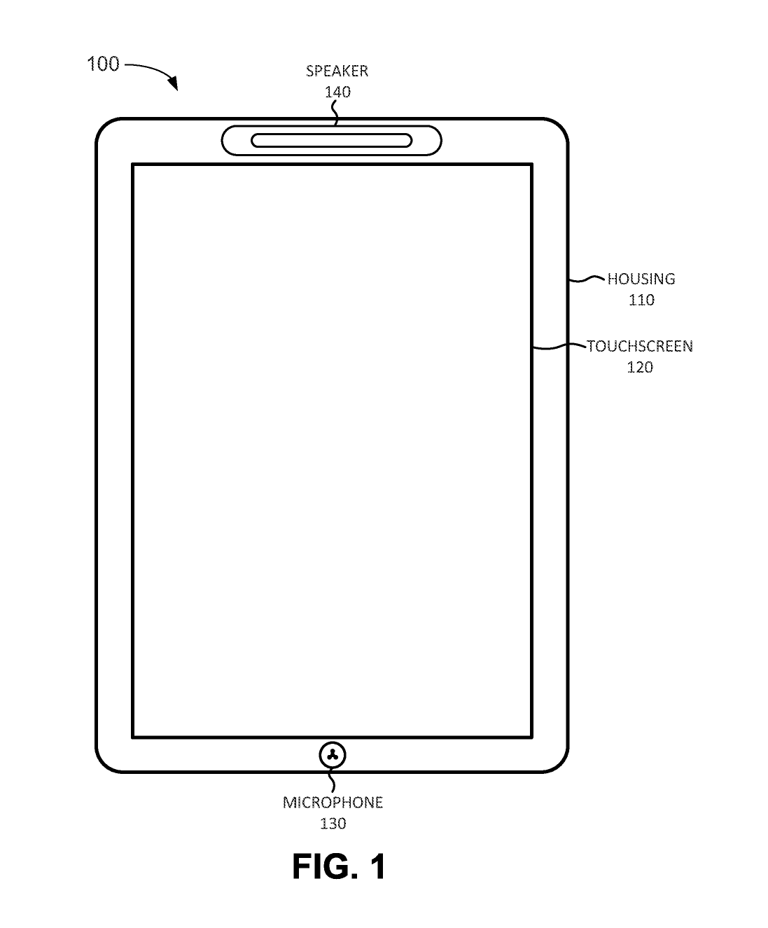

FIG. 1 is a diagram of an exemplary computer device 100 according to an implementation described herein. Computer device 100 may include any device with a touchscreen, such as a mobile phone, a smart phone, a phablet device, a tablet computer, a laptop computer, a desktop computer, a personal digital assistant (PDA), a media playing device, and/or another type of portable communication device. As shown in FIG. 1, computer device 100 may include a housing 110, a touchscreen 120, a microphone 130, and a speaker 140.

Housing 110 may enclose computer device 100 and may protect the components of computer device 100 from the outside environment. Touchscreen 120 may include a display device that includes an input device configured to detect a user's touch. For example, touchscreen 120 may include a liquid crystal display (LCD), an electronic ink display (e.g., an electrophoretic display), an electroluminescent display, and/or another type of display device. Furthermore, touchscreen 120 may include a set of touch sensors, such as a set of capacitive sensors (e.g., surface capacitive sensors, projected capacitive touch sensors, etc.), a set of resistive sensors (e.g., analog resistive sensors, digital resistive sensors, etc.), a set of optical sensors (e.g., optical imaging sensors, rear diffused illumination sensors, infrared grid sensors, diffused surface illumination sensors, etc.), a set of acoustic wave sensors (e.g., surface acoustic wave sensors, bending wave sensors, etc.), and/or a set of another type of touch sensors. Furthermore, touchscreen 120 may include a set of force sensors to sense an amount of force being applied to touchscreen 120, such as a set of piezoresistive sensors.

Microphone 130 may function as an input device that receives audio signals and converts the received audio signals to electrical signals. Speaker 140 may function as an output device that receives electrical signals and generates audio signals based on the received electrical signals. Computer device 100 may include additional sensors (not shown in FIG. 1). For example, computer device 100 may include one or more tilt sensors, such as accelerometers and/or gyroscopes, configured to sense a tilt, position, and/or orientation in space of computer device 100.

Although FIG. 1 show exemplary components of computer device 100, in other implementations, computer device 100 may include fewer components, different components, differently arranged components, or additional components than depicted in FIG. 1. Additionally or alternatively, one or more components of computer device 100 may perform functions described as being performed by one or more other components of computer device 100.

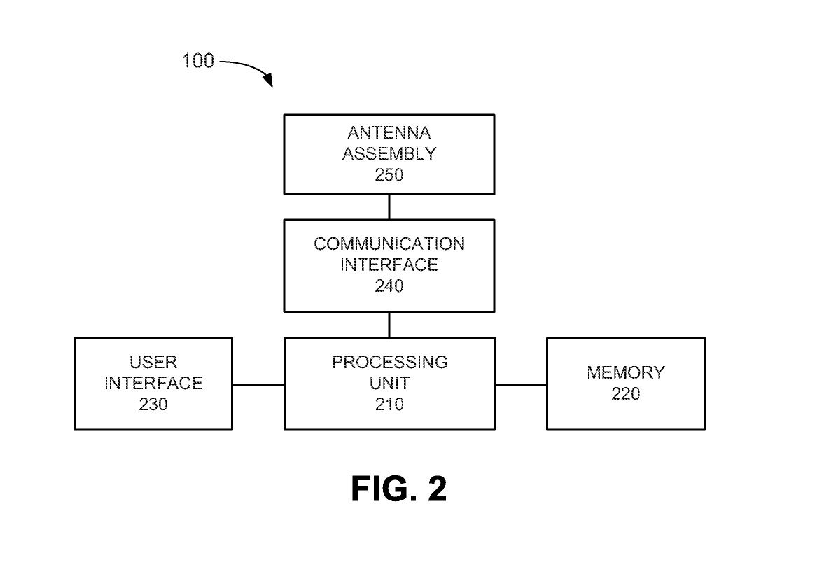

FIG. 2 is a diagram illustrating example components of a computer device 100 according to an implementation described herein. As shown in FIG. 2, device 100 may include a processing unit 210, a memory 220, a user interface 230, a communication interface 240, and an antenna assembly 250.

Processing unit 210 may include one or more processors, microprocessors, application specific integrated circuits (ASICs), field programmable gate arrays (FPGAs), and/or other processing logic. Processing unit 210 may control operation of computer device 100 and its components.

Memory 220 may include a random access memory (RAM) or another type of dynamic storage device, a read only memory (ROM) or another type of static storage device, a removable memory card, and/or another type of memory to store data and instructions that may be used by processing unit 210.

User interface 230 may include mechanisms for inputting information to computer device 100 and/or for outputting information from computer device 100. Examples of input and output mechanisms might include a speaker to receive electrical signals and output audio signals (e.g., speaker 140); a camera lens to receive image and/or video signals and output electrical signals; a microphone to receive audio signals and output electrical signals (e.g., microphone 130); buttons (e.g., a joystick, control buttons, a keyboard, or keys of a keypad) and/or a touchscreen to permit data and control commands to be input into computer device 100 (e.g., touchscreen 120); a display, such as an LCD, to output visual information (e.g., touchscreen 120); a vibrator to cause computer device 100 to vibrate; and/or any other type of input or output device.

Communication interface 240 may include a transceiver that enables computer device 100 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 240 may include a transmitter that converts baseband signals to radio frequency (RF) signals and/or a receiver that converts RF signals to baseband signals. Communication interface 240 may be coupled to antenna assembly 250 for transmitting and receiving RF signals.

Communication interface 240 may include a logical component that includes input and/or output ports, input and/or output systems, and/or other input and output components that facilitate the transmission of data to other devices. For example, communication interface 240 may include a network interface card (e.g., Ethernet card) for wired communications and/or a wireless network interface (e.g., a WiFi) card for wireless communications. Communication interface 240 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

Antenna assembly 250 may include one or more antennas to transmit and/or receive RF signals over the air. Antenna assembly 250 may, for example, receive RF signals from communication interface 240 and transmit the signals over the air and receive RF signals over the air and provide them to communication interface 240.

As described herein, computer device 100 may perform certain operations in response to processing unit 210 executing software instructions contained in a computer-readable medium, such as memory 220. A computer-readable medium may be defined as a non-transitory memory device. A non-transitory memory device may include memory space within a single physical memory device or spread across multiple physical memory devices. The software instructions may be read into memory 220 from another computer-readable medium or from another device via communication interface 240. The software instructions contained in memory 220 may cause processing unit 210 to perform processes that will be described later. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of computer device 100, in other implementations, computer device 100 may include fewer components, different components, differently arranged components, or additional components than depicted in FIG. 2. Additionally or alternatively, one or more components of computer device 100 may perform the tasks described as being performed by one or more other components of computer device 100.

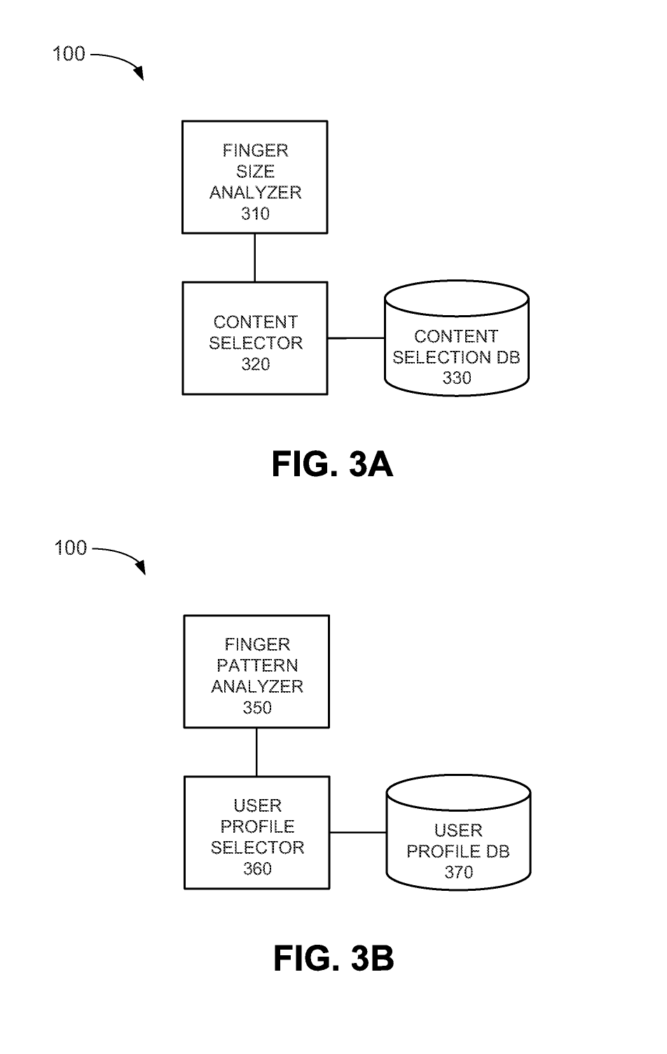

FIG. 3A is a diagram illustrating exemplary functional components of computer device 100 according to a first implementation described herein. The functional components of computer device 100 may be implemented, for example, via processing unit 210 executing instructions from memory 220. Alternatively, some or all of the functional components of computer device 100 may be implemented via hard-wired circuitry. As shown in FIG. 3A, computer device 100 may include a finger size analyzer 310, a content selector 320, and a content selection database (DB) 330.

Finger size analyzer 310 may determine a contact area of a finger touching touchscreen 120 and may determine, or estimate, a size of the contact area. In some implementations, finger size analyzer 310 may determine the size of the contact area by calculating the area of the contact area. In other implementations, finger size analyzer 310 may determine the size of the contact area by calculating a first length of the contact area in a first direction (e.g., a horizontal direction) and by calculating a second length of the contact area in a second direction (e.g., a vertical direction). In some implementations, finger size analyzer 310 may be configured to distinguish between a fingerprint and a thumbprint based on the shape of the contact area.

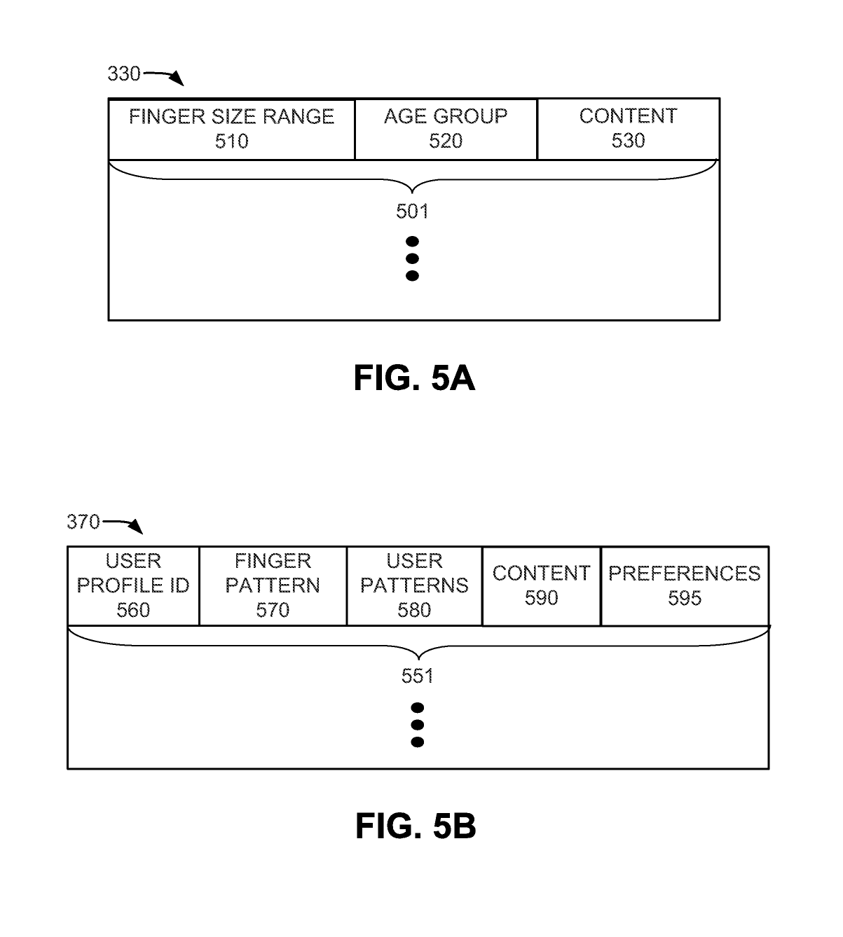

Content selector 320 may select content to be presented via touchscreen 120 based on a determined finger size by accessing content selection DB 330. For example, content selector 320 may determine a finger size range based on the determined contact area of the finger, determine an age group associated with the finger size range, and determine content associated with the age group. In some implementations, content selector 320 may use a first size range for a fingerprint and a second size range for a thumbprint. Content selection DB 330 may store information that associates particular content with particular age groups. Exemplary information that may be stored in content selection DB 330 is described below with reference to FIG. 5A.

The content that is selected and presented via touchscreen 120 by content selector 320 may be based on the context in which the finger was detected. For example, if the finger was detected as the user is unlocking and/or activating computer device 100, the selected content may include particular application icons that are displayed on touchscreen 100. As another example, if the finger was detected as the user is activating a particular application, the selected content may include particular content associated with the particular application.

Although FIG. 3A shows exemplary functional components of computer device 100, in other implementations, computer device 100 may include fewer functional components, different functional components, differently arranged functional components, or additional functional components than depicted in FIG. 3A. Additionally or alternatively, one or more functional components of computer device 100 may perform functions described as being performed by one or more other functional components of computer device 100.

FIG. 3B is a diagram illustrating exemplary functional components of computer device 100 according to a second implementation described herein. As stated above, the functional components of computer device 100 may be implemented, for example, via processing unit 210 executing instructions from memory 220. Alternatively, some or all of the functional components of computer device 100 may be implemented via hard-wired circuitry. As shown in FIG. 3B, computer device 100 may include a finger pattern analyzer 350, a user profile selector 360, and a user profile database (DB) 370.

Finger pattern analyzer 350 may determine a finger pattern based on a contact area of a finger touching touchscreen 120. Furthermore, finger pattern analyzer 350 may identify the finger pattern as corresponding to a particular finger pattern associated with a particular user profile stored in computer device 100. If finger pattern analyzer 350 is unable to identify a particular finger pattern from a set of finger patterns associated with user profiles stored in computer device 100, finger pattern analyzer 350 may indicate that a default user profile should be selected. Moreover, finger pattern analyzer 350 may collect information about users during use of computer device 100 in order to associate particular finger patterns with particular user profiles.

User profile selector 360 may select a user profile based on the finger pattern identified by finger pattern analyzer 350 and may select content to be presented via touchscreen 120 based on a determined finger pattern by accessing user profile DB 370. User profile selector 360 may use additional information in selecting a user profile. For example, user profile selector 360 may determine a tilt pattern of computer device 100, may determine an audio pattern detected by microphone 130, and/or may determine a pressure pattern detected by one or more pressure sensors of touchscreen 120. User profile selector 360 may use the additional information, together with the determined finger pattern, in selecting a particular user profile from a set of user profiles stored in computer device 100. User profile DB 370 may store information that associates particular content with particular user profiles. Exemplary information that may be stored in user profile DB 370 is described below with reference to FIG. 5B.

The user profile that is selected and presented via touchscreen 120 by user profile selector 360 may be based on the context in which the finger was detected. For example, if the finger was detected as the user is unlocking and/or activating computer device 100, the selected content may include particular application icons that are associated with the selected user profile. As another example, if the finger was detected as the user is activating a particular application, the selected content may include particular application content associated with the selected user profile.

Although FIG. 3B shows exemplary functional components of computer device 100, in other implementations, computer device 100 may include fewer functional components, different functional components, differently arranged functional components, or additional functional components than depicted in FIG. 3B. Additionally or alternatively, one or more functional components of computer device 100 may perform functions described as being performed by one or more other functional components of computer device 100.

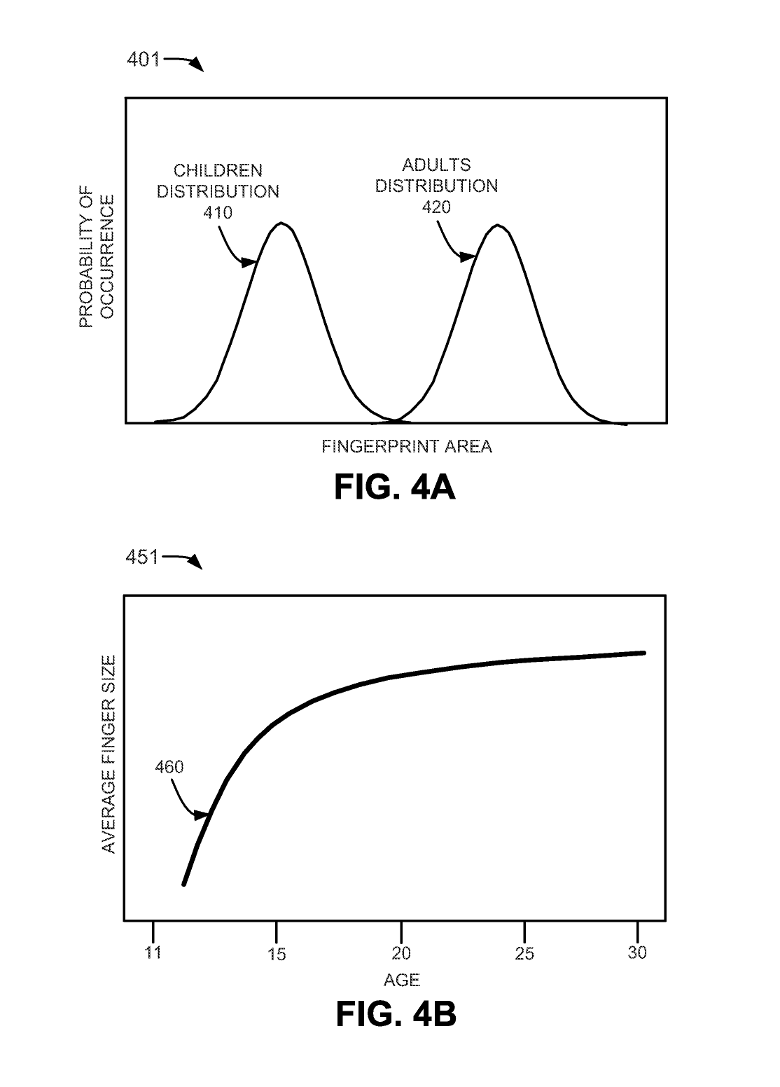

FIG. 4A is a graph 401 of fingerprint area distributions according to an implementation described herein. As shown in FIG. 4A, graph 401 may relate the probability of occurrence with particular fingerprint areas. Graph 401 may include a child distribution 410 and an adults distribution 420. Child distribution 410 may indicate a distribution of fingerprint sizes for children. Thus, child distribution 410 may indicate what percentage of children have a fingerprint size within a particular fingerprint size range. Adults distribution 420 may indicate a distribution of fingerprint sizes for adults. Thus, adults distribution 420 may indicate what percentage of adults have a fingerprint size within a particular fingerprint size range.

Graph 401 may be used by finger size analyzer 310 to determine whether a finger touching touchscreen 120 corresponds to a finger of a child or a finger of an adult. In other implementations, graph 401 may include different and/or additional finger size distributions. For example, graph 401 may include finger distributions for multiple age ranges.

FIG. 4B is a graph 451 of a relationship between age and average finger size according to an implementation described herein. As shown in FIG. 4B, graph 451 may include a finger size curve 460 that relates a particular age to a particular average finger size. Finger size curve 460 may be used by finger size analyzer 310 to determine a particular age group for a user based on the finger size of the user's finger touching touchscreen 120.

FIG. 5A is a diagram of exemplary components of content selection database 330 according to an implementation described herein. As shown in FIG. 5A, content selection database 330 may include one or more age group entries 501 (referred to herein collectively as “age group entries 501” and individually to “age group entry 501”). Each age group entry 501 may relate a particular age group to particular content. Age group entry 501 may include a finger size range field 510, an age group field 520, and a content field 530.

Finger size range field 510 may identify a particular finger size range associated with the particular age group associated with age group entry 501. In some implementations, finger size range field 510 may include a range of fingerprint areas associated with the particular age group. In other implementations, finger size range field 510 may include one or more sets of length ranges (e.g., a finger width range and a finger length range) associated with the particular age group. In some implementations, finger size range field 510 may store a first size range for a fingerprint and a second size range for a thumbprint.

Age group field 520 may identify a particular age range for the particular age range. In some implementations, content selection database 330 may include two age group entries 501, one for children and one for adults. In other implementations, content selection database 330 may include more than two age group entries 501 and each age group entry 501 may identify a particular age range. For example, content selection database 330 may include a first age group entry 501 for the age range 0-7 years, a second age group entry 501 for the age range 7-13 years, a third age group entry 501 for the age range 14-18 years, and a fourth age group entry 501 for the age range over 18 years.

Content field 530 may identify content associated with the particular age group. For example, content field 530 may identify applications associated with the particular age group. The applications may be ranked based on one or more criteria. In some implementations, the applications may be ranked based on popularity with users of computer device 100. In other implementations, the applications may be ranked based on global popularity (e.g., popularity of applications with a community of users). Additionally or alternatively, the applications may be classified based on categories and a particular number of applications may be presented for particular application categories.

Furthermore, content field 530 may identify content associated with a particular age group for a particular application. For example, for a children age group entry 501 for a movie streaming application, content field 530 may identify recently released children movies. Alternatively, content field 530 may include information that may be sent in a request by a particular application when requesting content from a server device. For example, for the movie streaming application, content field 530 may include a query string (e.g., “age category=children”, or another type of identifier, that may be included in a request to a server device for a list of available movies. Additionally or alternatively, content field 530 may include a particular user navigation flow within an application. For example, content field 530 may specify a sequence of user interfaces that should be displayed to users of the particular age group in connection with the particular application.

Although FIG. 5A shows exemplary components of content selection DB 330, in other implementations, content selection DB 330 may include fewer components, different components, differently arranged components, or additional components than depicted in FIG. 5A.

FIG. 5B is a diagram of exemplary components of user profile DB 370 according to an implementation described herein. As shown in FIG. 5B, user profile DB 370 may include one or more age user profile records 551 (referred to herein collectively as “user profile records 551” and individually to “user profile record 551”). Each user profile record 551 may store user profile information for a particular user of computer device 100. In some implementations, user profile record 551 may be explicitly created by a user. In other implementations, user profile record 551 may be generated for a user based on information obtained for the user. For example, user profile information for computer device 100 may be generated based on a user profile created by the user for a particular application. As another example, user profile record 551 may be generated based on a new detected finger pattern of a user using computer device 100.

User profile record 551 may include a user profile identifier (ID) field 560, a finger pattern field 570, a user patterns field 580, a content field 590, and a preferences field 595.

User profile ID field 560 may store information identifying a particular user. For example, user profile ID field 560 may store a user's name, a user's username, and/or another type of user identifier. Finger pattern field 570 may store a finger pattern (e.g., size and shape of a contact area of a finger) of a fingerprint associated with the particular user. Furthermore, finger pattern field 570 may store a finger pattern for a thumbprint associated with the particular user.

User patterns field 580 may store additional patterns associated with the particular user. As an example, user patterns field 580 may include a gesture pattern associated with the particular user. For example, the particular user may perform a particular gesture (e.g., a finger swipe in a particular length and direction) when dragging a lock icon to unlock computer device 100. The particular gesture may be used to further identify the particular user.

As another example, user patterns field 580 may store a tilt pattern associated with the particular user. The tilt pattern may be based on a preferred angle and/or orientation of computer device 100 when the particular user is holding computer device 100. For example, a first user of computer device 100 may hold computer device 100 at a first angle and a second user of computer device 100 may hold computer device 100 at a second angle and the difference in the angles may be used to distinguish between the first user and the second user.

As yet another example, user patterns field 580 may store an audio pattern associated with the particular user. The audio pattern may be based on a voice associated with the particular user. For example, a user may be talking while using computer device 100 and the user's voice may be used to identify the particular user. As yet another example, user patterns field 580 may store a pressure pattern associated with the particular user. For example, touchscreen 120 may include one or more force sensors to sense an amount of pressure being applied to touchscreen 120. A first user may apply a first amount of pressure to touchscreen 120 when touching touchscreen 120 and a second user may apply a second amount of pressure to touchscreen 120 and the difference in pressure amount may be used to distinguish between the first user and the second user.

Content field 590 may store information identifying content associated with the particular user. For example, content field 590 may identify applications associated with the particular user. The applications may be ranked based on one or more criteria, such as frequency of use. When the particular user activates computer device 100, application icons associated with the user's applications may be displayed on touchscreen 120. Additionally or alternatively, the applications may be classified based on categories and a particular number of applications may be presented for particular application categories.

Furthermore, content field 590 may identify content associated with the particular user for a particular application. For example, content field 590 may identify a user profile for the particular user for a particular application. Alternatively, content field 590 may include information that may be sent in a request by a particular application when requesting content from a server device. For example, for a movie streaming application, content field 590 may include a query string (e.g., “username=particular_user”), or another type of identifier, that may be included in a request to a server device to obtain content associated with the particular user.

Preferences field 595 may include one or more preferences associated with the user. While preferences associated with particular applications may be stored in connection with application user profiles identified in content field 590, other preferences may not be tied to specific applications and may be stored in preferences field 595. For example, preferences field 595 may store a volume level associated with the particular user, a screen brightness level associated with the particular user, a touchscreen responsiveness level associated with the user, an icon size associated with the particular user, a text font and/or text size associated with the particular user, a color scheme associated with the particular user, and/or other preferences associated with the particular user.

Although FIG. 5B shows exemplary components of user profile DB 370, in other implementations, user profile DB 370 may include fewer components, different components, differently arranged components, or additional components than depicted in FIG. 5B.

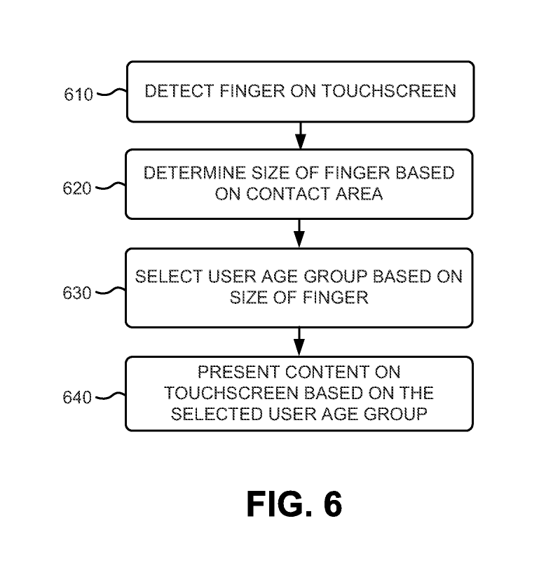

FIG. 6 is a flowchart of an exemplary process of selecting content based on a finger size according to an implementation described herein. In one implementation, the process of FIG. 6 may be performed by computer device 100. In other implementations, some or all of the process of FIG. 6 may be performed by another device or a group of devices separate from computer device 100 and/or including computer device 100.

The process of FIG. 6 may include detecting a finger on a touchscreen (block 610). As an example, a user may activate computer device 100 by touching or moving a lock icon, or by touching any area of touchscreen 120. As another example, the user may activate an application by touching an application icon being displayed on touchscreen 120. As yet another example, the user may interact with an application running on computer device 100 by touching a selection object (e.g., a button, a hyperlink, a scrollbar, etc.) being displayed by the application via touchscreen 120.

A size of the finger may be determined, or estimated, based on the contact area (block 620). For example, finger size analyzer 310 may determine the size of the contact area of the finger touching touchscreen 120. In some implementations, finger size analyzer 310 may further determine whether the finger corresponds to a finger or a thumb based on the shape of the contact area.

A user age group may be selected based on the size of the finger (block 630). For example, content selector 320 may access content selection DB 330 and may select a user age group entry 501 based on the determined size of the contact area of the finger. Content may be presented on the touchscreen based on the selected user age group (block 640). For example, content selector 320 may present content associated with the selected age group, based on information stored in content field 530 of the selected user age group entry 501. As an example, content selector 320 may display application icons associated with the selected user age group when the user has activated computer device 100. As another example, content selector 320 may display application content associated with a selected application when the user activates an application and/or when the user is interacting with an application.

In some implementations, the user may be wearing a touchscreen glove. The touchscreen glove may include a particular finger pattern. For example, operators at a company may be provided with touchscreen gloves and each department or function may be associated with a particular touchscreen glove type with a particular pattern. For example, sales operators may be provided with a first type of touchscreen glove and customer service operators may be provided with a second type of touchscreen glove. A particular touchscreen glove type may include a contact area finger pattern of a particular size and shape. Finger size analyzer 310 may identify a particular touchscreen glove type based on the contact area finger pattern and content selector 320 may select particular content associated with the identified touchscreen glove type. The particular content may include, for example, a particular sequence of user interfaces that are presented to the user (e.g., a series of user interfaces for completing a sale).

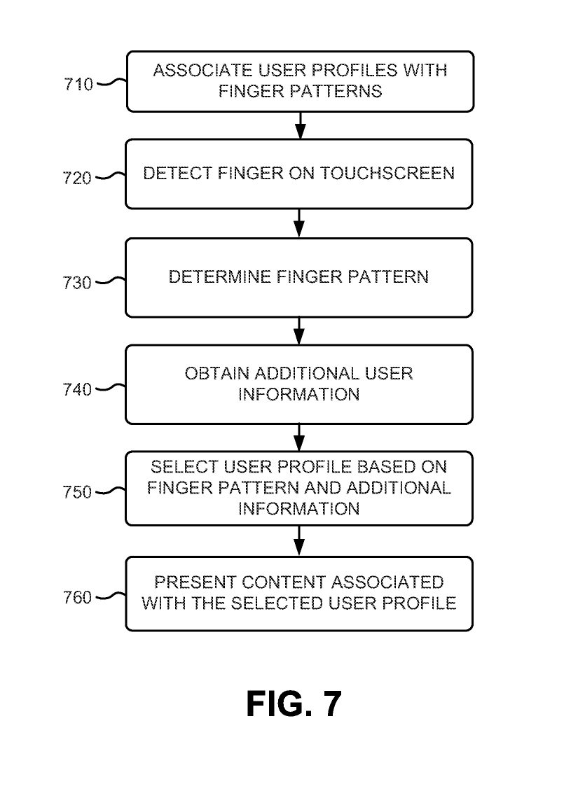

FIG. 7 is a flowchart of an exemplary process of selecting content based on a finger pattern according to an implementation described herein. In one implementation, the process of FIG. 7 may be performed by computer device 100. In other implementations, some or all of the process of FIG. 7 may be performed by another device or a group of devices separate from computer device 100 and/or including computer device 100.

The process of FIG. 7 may include associating user profiles with finger patterns (block 710). For example, finger pattern analyzer 350 may collect finger pattern information associated with users of computer device 100. In some implementations, when finger pattern analyzer 350 detects a finger pattern that cannot be matched to an existing user profile, finger pattern analyzer 350 may prompt the user to generate a user profile. The user may be guided through a process of providing a fingerprint and/or a thumb print. Furthermore, the user may be prompted to select preferred applications. Moreover, user profiles associated with particular applications may be identified and associated with the generated user profile.

In other implementations, a user profile may be generated without prompting the user for information. For example, a new user profile may be generated for the detected finger pattern and user preferences may be determined based on the user's use of computer device 100. For example, the applications used by the user associated with the detected finger pattern may be associated with the new user profile. As another example, a selection of a user profile may be detected while the user is using an application (e.g., the user may log into an account associated with the application) and the user profile may be associated with the detected finger pattern.

Furthermore, once a finger pattern is associated with a user profile, additional information may be associated with the user profile. As an example, user profile selector 360 may detect selection of a user profile, may determine a tilt pattern of computer device 100 while the user profile is selected, and may associate the determined tilt pattern with the selected user profile. As another example, user profile selector 360 may detect selection of a user profile, may determine an audio pattern of computer device 100 while the user profile is selected, and may associate the determined audio pattern with the selected user profile. As yet another example, user profile selector 360 may detect selection of a user profile, may determine a pressure pattern of computer device 100 while the user profile is selected, and may associate the determined pressure pattern with the selected user profile.

A finger on a touchscreen may be detected (block 720). As an example, a user may activate computer device 100 by touching or moving a lock icon, or by touching any area of touchscreen 120. As another example, the user may activate an application by touching an application icon being displayed on touchscreen 120. As yet another example, the user may interact with an application running on computer device 100 by touching a selection object (e.g., a button, a hyperlink, a scrollbar, etc.) being displayed by the application via touchscreen 120.

A finger pattern may be determined (block 730). For example, finger pattern analyzer 350 may determine the finger pattern (e.g., size and shape) of the contact area of the detected finger with touchscreen 120. Additional user information may be obtained (block 740). For example, finger pattern analyzer 350 may obtain additional patterns associated with the user using computer device 100. Finger pattern analyzer 350 may obtain a gesture pattern that the detected finger touching touchscreen 120 makes, finger pattern analyzer 350 may obtain a pressure pattern based on how much pressure the detected finger applies to touchscreen 120, finger pattern analyzer 350 may obtain a tilt pattern based on how computer device 100 is tilted while the user is holding computer device 100, finger pattern analyzer 350 may obtain an audio pattern if the user is talking while using computer device 100, and/or finger pattern analyzer 350 may obtain another type of pattern associated with the user.

A user profile may be selected based on the finger pattern and based on the additional information (block 750). For example, user profile selector 360 may select a user profile record 551 that best matches the determined finger pattern and/or the obtained additional information. If no user profile record 551 stored in user profile DB 370 matches the determined finger pattern and/or the obtained additional information, user profile selector 360 may select a default user profile and/or may generate a new user profile based on the determined finger pattern.

Content associated with the selected user profile may be selected (block 760). For example, user profile selector 360 may present content associated with the selected user profile, based on information stored in content field 590 of the selected user profile record 551. As an example, user profile selector 360 may display application icons associated with the selected user profile when the user has activated computer device 100. As another example, user profile selector 360 may display application content associated with a selected application based on the selected user profile, when the user activates an application and/or when the user is interacting with an application. Furthermore, user profile selector 360 may adjust one or more settings of computer device 100 based on information stored in preferences field 595 of user profile record 551. For example, user profile selector 360 may adjust a volume level of computer device 100, may adjust a screen brightness level of computer device 100, may adjust a touchscreen responsiveness level of computer device 100, may adjust an icon size of icons displayed by computer device 100, may adjust a text font and/or text size of text displayed by computer device 100, may adjust a color scheme of computer device 100, and/or may adjust other preferences of computer device 100.

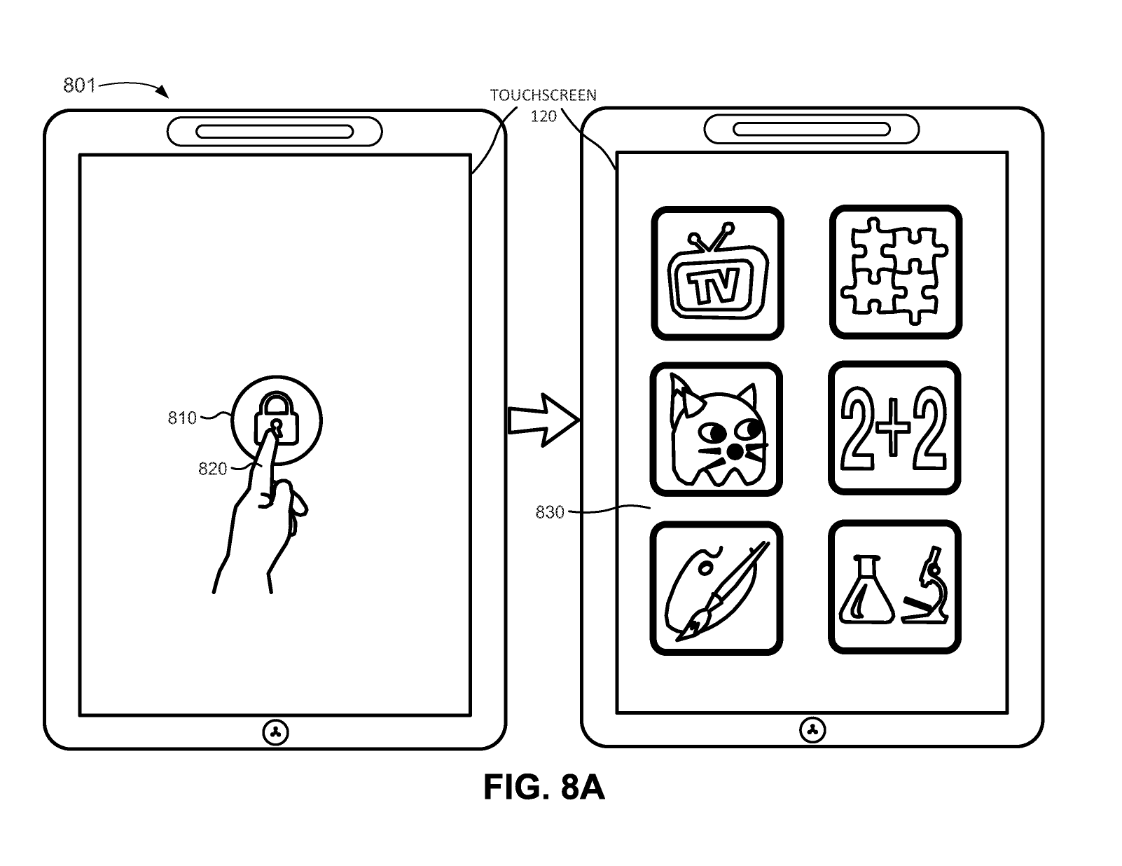

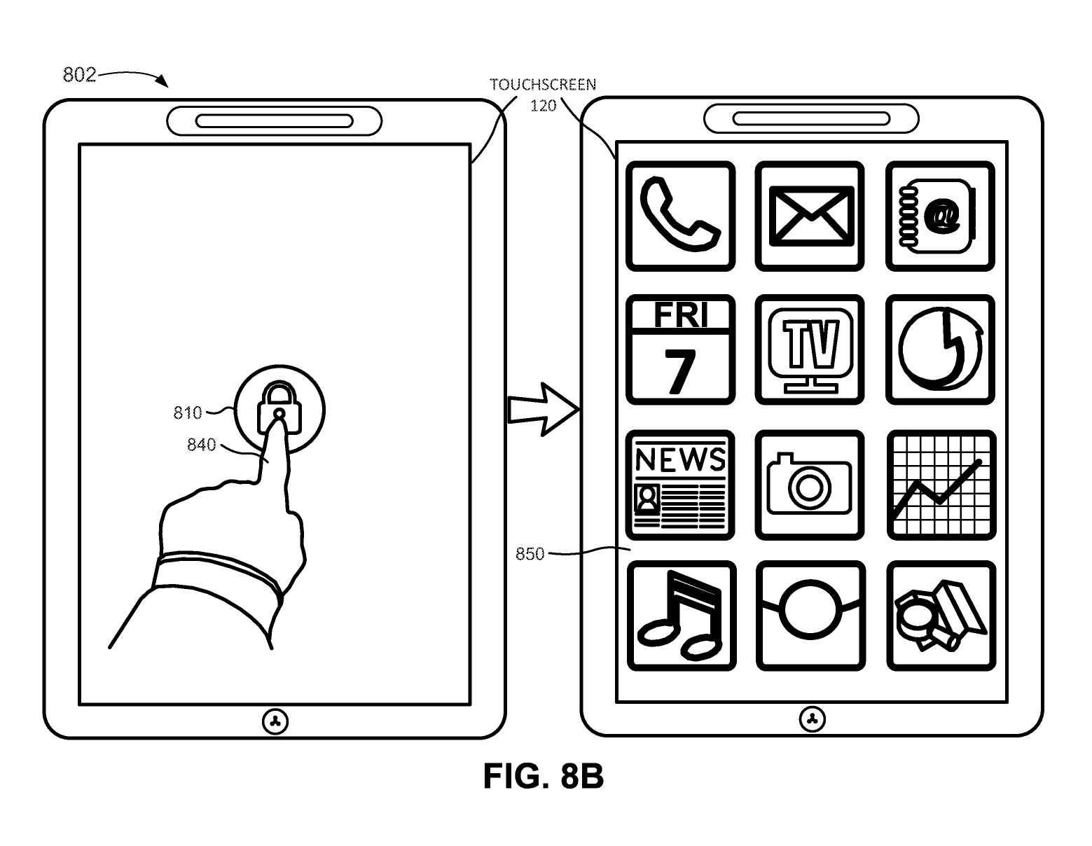

FIGS. 8A and 8B are first exemplary user interfaces according to an implementation described herein. FIG. 8A shows an example 801 of content being presented via touchscreen 120 in response to a child activating computer device 100. Touchscreen 120 may include a lock icon 810 that may need to be activated to begin using computer device 100. A child finger 820 may be detected touching lock icon 810 based on the size of child finger 820. In response to detecting child finger 820, children content 830 may be presented via touchscreen 120. Children content 830 may include application icons for applications intended for children, such as an application to present children television content, children game applications, and/or education applications intended for children in a particular age range.

FIG. 8B shows an example 802 of content being presented via touchscreen 120 in response to an adult activating computer device 100. An adult finger 840 may be detected touching lock icon 810 based on the size of adult finger 840. In response to detecting adult finger 840, content 850 intended for adults may be presented via touchscreen 120. Content 850 for adults may include, for example, a phone application, an email application, an address book application, a calendar application, a television application, a browser application, a news application, a camera application, a financial application, a music application, a weather application, and/or a mapping application.

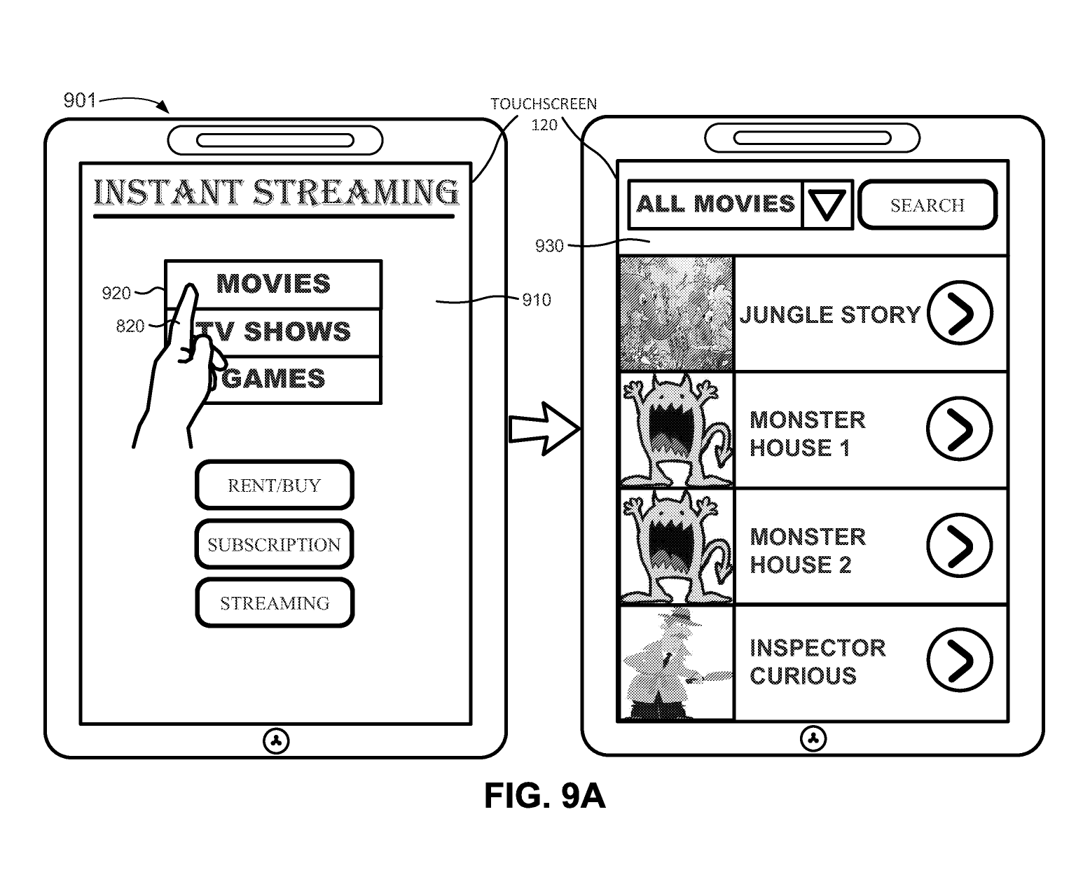

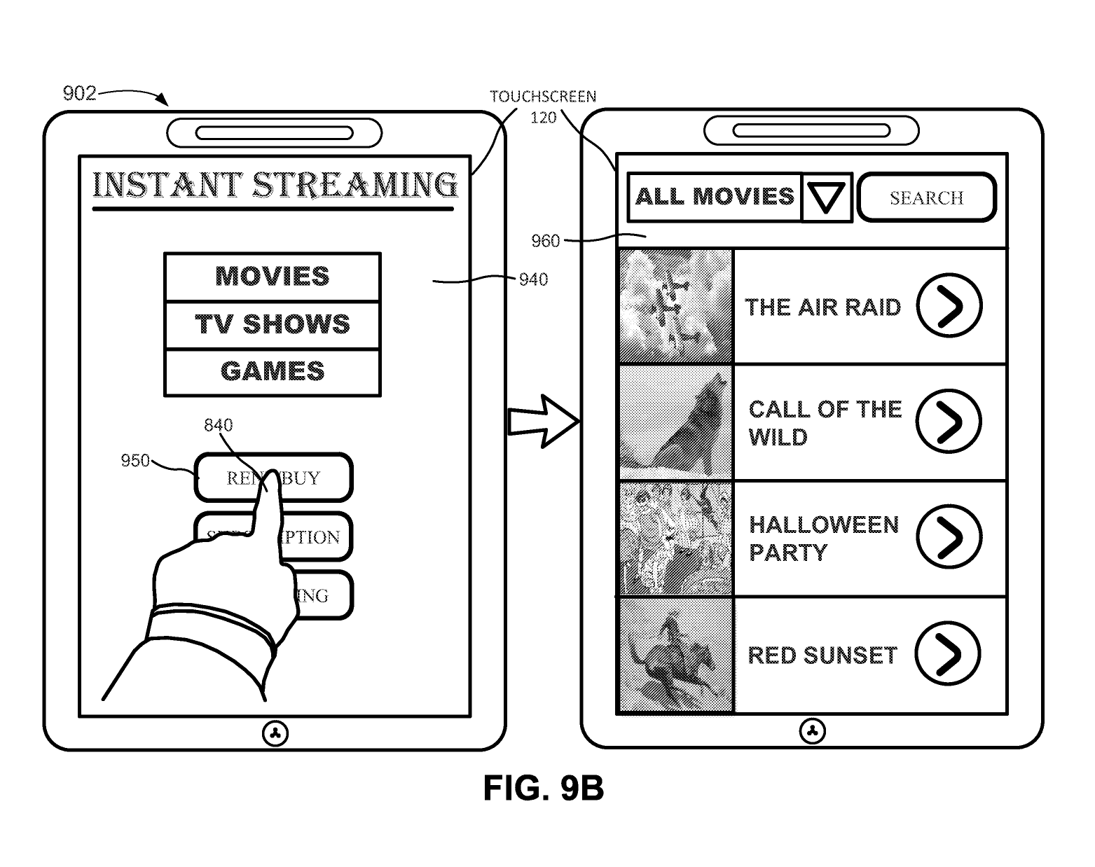

FIGS. 9A and 9B are second exemplary user interfaces according to an implementation described herein. FIG. 9A shows an example 901 of content being presented via touchscreen 120 in response to a child interacting with a particular application. Touchscreen 120 may be displaying a selection screen 910 associated with a movie application. Child finger 820 may be detected touching a movie selection button 920. In response to detecting child finger 820, children movies 930 may be presented by the movie application via touchscreen 120.

FIG. 9B shows example 902 of content presented via touchscreen 120 in response to an adult interacting with the movie application. Adult finger 840 may be detected touching a rent/buy button 950 to rent or buy available movies. In response to detecting adult finger 840, recently available movies 960 intended for an adult audience may be presented by the movie application via touchscreen 120.

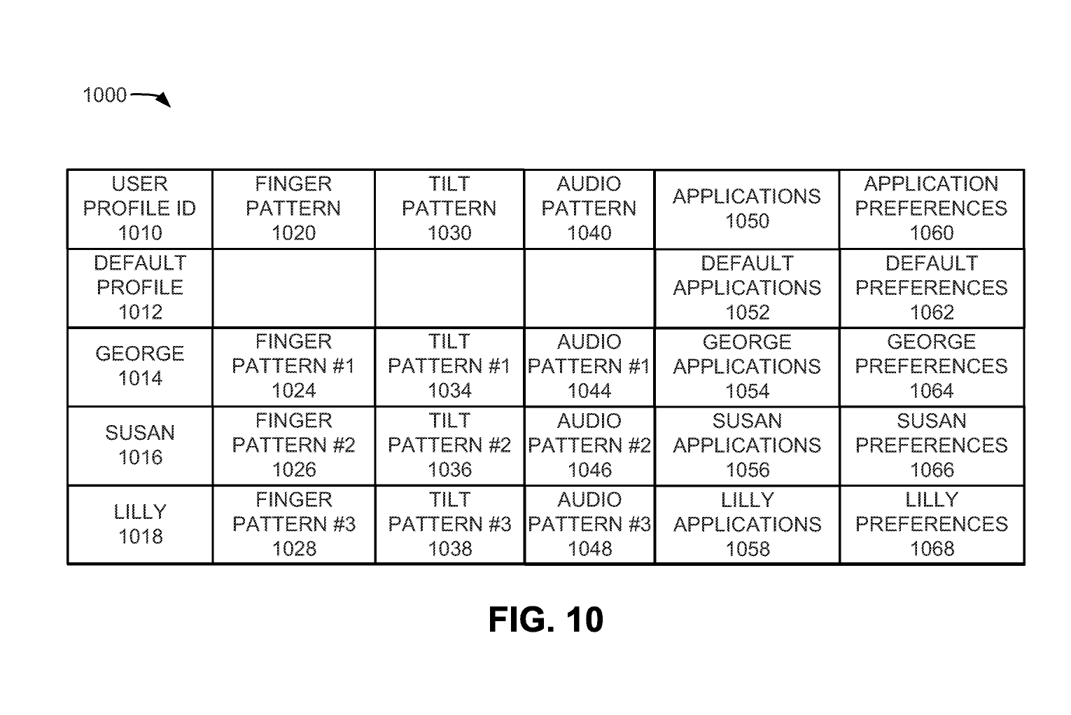

FIG. 10 is a diagram of an exemplary table 1000 of user profiles according to an implementation described herein. Assume that three different users from a family are using computer device 100. Table 1000 may include four user profiles and each user profile may include an entry for a user profile ID field 1010, a finger pattern field 1020, a tilt pattern field 1030, an audio pattern field 1040, an applications field 1050, and an applications preferences field 1060.

Table 1000 may include a default profile 1012 that may be used when a particular user cannot be selected or identified. For example, the information obtained by user profile selector 360 may be insufficient to identify one of the user profiles or a new user may be using computer device 100. Default profile 1012 may be associated with default applications 1052 and default preferences 1062 associated with the default applications 1062. Table 1000 may include a first user profile 1014 for a user named George. First user profile 1014 may include a first finger pattern 1024 associated with George, a first tilt pattern 1034 associated with George, and a first audio pattern 1044 associated with George. Furthermore, first user profile 1014 may identify a first set of applications 1054 associated with George and a set of application preferences 1064 associated with George. Table 1000 may include a second user profile 1016 for a user named Susan. Second user profile 1016 may include a second finger pattern 1026 associated with Susan, a second tilt pattern 1036 associated with Susan, and a second audio pattern 1046 associated with Susan. Furthermore, second user profile 1016 may identify a second set of applications 1056 associated with Susan and a set of application preferences 1066 associated with Susan. Table 1000 may include a third user profile 1018 for a user named Lilly. Third user profile 1018 may include a third finger pattern 1028 associated with Lilly, a third tilt pattern 1038 associated with Lilly, and a third audio pattern 1048 associated with Lilly. Furthermore, third user profile 1018 may identify a third set of applications 1058 associated with Lilly and a set of application preferences 1068 associated with Lilly.

When a particular finger pattern, tilt pattern, and/or audio pattern is detected, one of the user profiles may be selected and computer device 100 may present the appropriate applications and/or may provide computer device 100 with the appropriate application preferences based on the identified profile. If no user profile is identified, computer device 100 may select default user profile 1012 and may present the default applications along with the default preferences.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with respect to FIGS. 6 and 7, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method, performed by a computer device, the method comprising:
detecting, by the computer device, a finger on a touchscreen;
determining, by the computer device, a finger pattern based on a contact area of the finger with the touchscreen;
selecting, by the computer device, content based on the determined finger pattern; and
presenting, by the computer device, the selected content on the touchscreen.

2. The method of claim 1, wherein determining the finger pattern includes:
determining a size of the finger;
wherein the method further comprises:
selecting a user age group based on the determined size of the finger; and
wherein selecting content based on the determined finger pattern includes:
selecting content based on the selected user age group.

3. The method of claim 2, wherein detecting the finger on the touchscreen includes:
detecting an unlocking of the touchscreen; and
wherein selecting the content includes:
selecting a plurality of application icons based on the selected user age group.

4. The method of claim 2, wherein detecting the finger on the touchscreen includes:
detecting an activation of an application; and
wherein selecting the content includes:
selecting content associated with the application based on the selected user age group.

5. The method of claim 4, wherein selecting content associated with the application based on the selected user age group includes:
requesting content associated with the selected user age group from a web site associated with the application.

6. The method of claim 1, wherein determining the finger pattern includes:
determining a size and a shape of the contact area of the finger;
wherein the method further comprises:
selecting a user profile based on the determined size and shape of the contact area; and
wherein selecting content based on the determined finger pattern includes:
selecting content based on the selected user profile.

7. The method of claim 6, further comprising:
detecting selection of the user profile;
determining the size and shape of the contact area of the finger while the user profile is selected; and
associating the size and shape of the contact area of the finger with the selected user profile.

8. The method of claim 6, further comprising:
determining a tilt pattern associated with the detecting of the finger on the touchscreen; and
wherein selecting the user profile based on the determined size and shape of the contact area includes:
selecting the user profile based on the determined tilt pattern.

9. The method of claim 8, further comprising:
detecting selection of the user profile;
determining the tilt pattern while the user profile is selected; and
associating the tilt pattern with the selected user profile.

10. The method of claim 6, further comprising:
determining an audio pattern associated with the detecting of the finger on the touchscreen; and
wherein selecting the user profile based on the determined size and shape of the contact area includes:
selecting the user profile based on the determined audio pattern.

11. The method of claim 10, further comprising:
detecting selection of the user profile;
determining the audio pattern while the user profile is selected; and
associating the audio pattern with the selected user profile.

12. A computer device comprising:
logic configured to:
detect a finger on a touchscreen;
determine a finger pattern based on a contact area of the finger with the touchscreen;
select content based on the determined finger pattern; and
present the selected content on the touchscreen.

13. The computer device of claim 12, wherein, when determining the finger pattern, the logic is further configured to:
estimate a size of the finger;
wherein the logic is further configured to:
select a user age group based on the determined size of the finger; and
wherein, when selecting the content based on the determined finger pattern, the logic is further configured to:
select content based on the selected user age group.

14. The computer device of claim 13, wherein, when detecting the finger on the touchscreen, the logic is further configured to:
detect an unlocking of the touchscreen; and
wherein, when selecting the content, the logic is further configured to:
select a plurality of application icons based on the selected user age group.

15. The computer device of claim 13, wherein, when detecting the finger on the touchscreen, the logic is further configured to:
detect an activation of an application; and
wherein, when selecting the content, the logic is further configured to:
select content associated with the application based on the selected user age group.

16. The computer device of claim 12, wherein, when determining the finger pattern, the logic is further configured to:
determine a size and a shape of the contact area of the finger;
wherein the logic is further configured to:
select a user profile based on the determined size and shape of the contact area; and
wherein, when selecting the content based on the determined finger pattern, the logic is further configured to:
select content based on the selected user profile.

17. The computer device of claim 16, wherein the logic is further configured to:
determine a tilt pattern associated with the detecting of the finger on the touchscreen;
determine an audio pattern associated with the detecting of the finger on the touchscreen; and
wherein, when selecting the user profile based on the determined size and shape of the contact area, the logic is further configured to:
select the user profile based on the determined tilt pattern and based on the determined audio pattern.

18. A non-transitory computer-readable medium, storing instructions executable by one or more processors, the non-transitory computer-readable medium comprising:
one or more instructions to detect a finger on a touchscreen;
one or more instructions to determine a finger pattern based on a contact area of the finger with the touchscreen;
one or more instructions to identify content based on the determined finger pattern; and
one or more instructions to present the identified content on the touchscreen.

19. The non-transitory computer-readable medium of claim 18, wherein the one or more instructions to determine the finger pattern further include:
one or more instructions to determine a size of the finger;
wherein the non-transitory computer-readable medium further comprises:
one or more instructions to select a user age group based on the determined size of the finger; and
wherein, the one or more instructions to select content based on the determined finger pattern further include:
one or more instructions to select content based on the selected user age group.

20. The non-transitory computer-readable medium of claim 18, wherein the finger is wearing a touchscreen glove, and wherein the one or more instructions to determine the finger pattern further include:
one or more instructions to determine a size and a shape of the contact area of the touchscreen glove; and
wherein, the one or more instructions to select content based on the determined finger pattern further include:
one or more instructions to select a sequence of user interfaces based on the contact area of the touchscreen glove.
